(19) United States
(12) Patent Application Publication
(10) Pub. No.: US 2009/0020998 A1
(43) Pub. Date: Jan. 22, 2009

(54) BOOK COVER

(76) Inventor: Deborah J. Gernenz, Winter Garden, FL (US)

Correspondence Address: BINGHAM MCHALE LLP, 2700 MARKET TOWER, 10 WEST MARKET STREET, INDIANAPOLIS, IN, 46204-4900, US

(21) Appl. No.: 11/779,275

(22) Filed: Jul. 17, 2007

(51) Int. Cl. B65D 71/04; A45F 5/12; B42D 3/18

(52) U.S. Cl. 281/31; 206/575; 294/138

(57) ABSTRACT

A book cover holds a coloring book and includes a removably mounted storage page that holds coloring implements such as crayons and the like. The storage page holds pages of the coloring book not being used out of the way while allowing easy access to the coloring implements. When not in use, the book cover allows the coloring book and crayons to be securely stored and transported.

### BACKGROUND

One of the treasured rites of childhood is the coloring book. Generations of children have first expressed themselves artistically by filling in the blank outlines of a coloring book using only their imaginations to guide their creative output.

### SUMMARY

The technology to be protected is set forth in the claims below, and the remainder of this disclosure is not in any way to limit, define or otherwise establish the scope of legal protection. In general terms, the disclosed technology relates to book covers that include configurable storage capabilities. In one embodiment, a book cover is adapted and configured to hold a coloring book and further includes a removably mounted storage page adapted to hold a plurality of coloring implements, such as crayons and the like.

Further embodiments, forms, benefits, aspects, features and advantages of the disclosed technology may be obtained from the description, drawings, and claims provided herein.

### BRIEF DESCRIPTION OF THE DRAWINGS

FIG. 1 is a front view of a book cover according to one embodiment of the disclosed technology.

FIG. 2 is a top view of the book cover in FIG. 1 from line A1.

FIG. 3 is a front view of a book cover according to another embodiment of the disclosed technology.

FIG. 4 is a top view of the book cover in FIG. 3 from line A2.

FIG. 5 is a top view of the book cover in FIG. 3 in a folded configuration.

FIG. 6 is a front view of a storage page according to a third embodiment of the disclosed technology.

FIG. 7 is a front view of a book cover according to a fourth embodiment of the disclosed technology.

FIG. 8 is a front view of a page holder according to a fifth embodiment of the disclosed technology.

FIG. 9 is a rear view of a page holder according to the fifth embodiment of the disclosed technology.

FIG. 10 is a coloring kit including a book cover according to a sixth embodiment of the disclosed technology.

FIG. 11 is a front view of a book cover according to a seventh embodiment of the disclosed technology.

FIG. 12 is a front view of a page holder for use with the seventh embodiment of the disclosed technology.

### DESCRIPTION

For the purposes of promoting an understanding of the principles of the disclosed technology and presenting its currently understood best mode of operation, reference will now be made to the embodiments illustrated in the drawings and specific language will be used to describe the same. It will nevertheless be understood that no limitation of the scope of the disclosed technology is thereby intended, with such alterations and further modifications in the illustrated device and such further applications of the principles of the disclosed technology as illustrated therein being contemplated as would normally occur to one skilled in the art to which the disclosed technology relates.

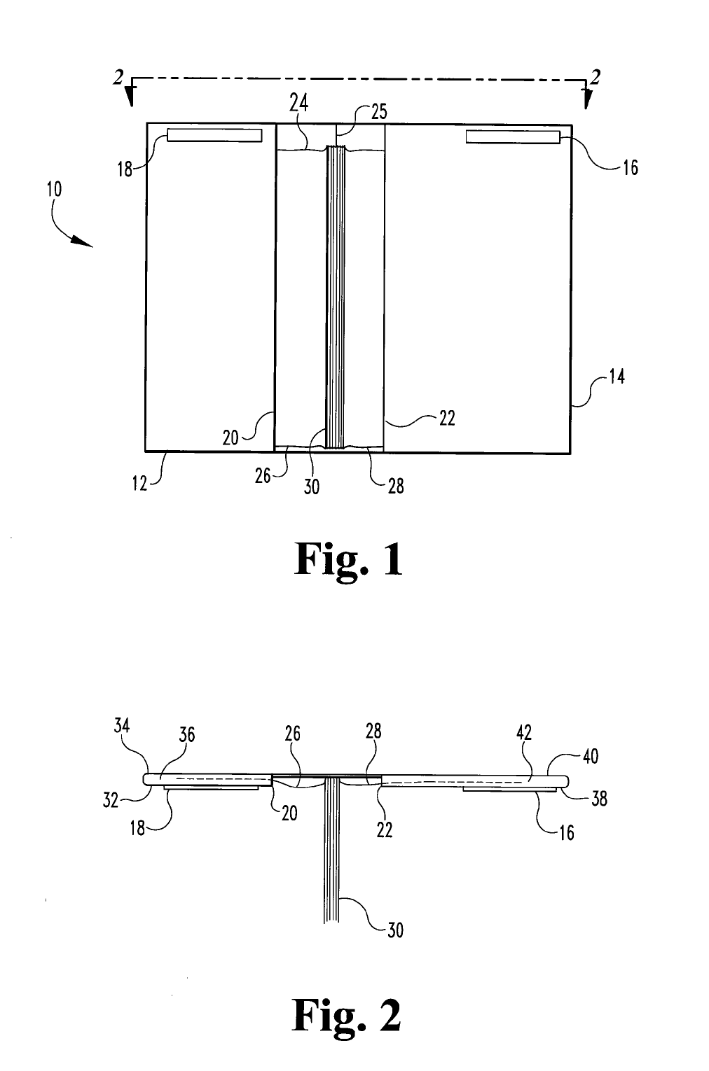

FIGS. 1-2 show a book cover 10 according to one embodiment of the disclosed technology. In this particular embodiment, the book cover 10 includes a first cover portion 12 and a second cover portion 14 and is capable of folding at a middle portion 25. First cover portion 12 includes an inner surface 32 and an outer surface 34 that together form a pocket 36 therebetween, which pocket 36 is accessible through a slot 20. First cover portion 12 further includes a fixing member 18, which may be a hook-and-loop type fastening system such as Velcro®, buttons, snaps, a zipper, an adhesive surface, magnets, another suitable fastening system, or a combination thereof. Second cover portion 14 includes an inner surface 38 and an outer surface 40 that form a pocket 42 therebetween, which pocket 42 is accessible through a slot 22. Second cover portion 14 further includes a fixing member 16, which may be a hook-and-loop type fastening system such as Velcro®, buttons, snaps, a zipper, an adhesive surface, magnets, another suitable fastening system, or a combination thereof.

Continuing with the present example, a coloring book 24 having a front cover 26, a rear cover 28, and a plurality of colorable pages 30 disposed therebetween is removably engaged with book cover 10 by inserting front cover 24 into pocket 36 through slot 20. Likewise, rear cover 28 is inserted into pocket 42 through slot 22. The size of pockets 36 and 42 is exaggerated for the sake of clarity as shown in FIG. 2. Book cover 10 may be made from a variety of suitable flexible materials such as cloth, plastic, and the like, or from stiffer materials such as cardboard, paperboard, or hard plastics, as desired. Optionally, portions of book cover 10 may be made from softer, more flexible materials such as cloth while other portions are made from or strengthened by harder, more stiff materials such as cardboard. For example, inner surfaces 32 and 38 may be made from a soft flexible cloth so as to allow for easy engagement and removal of coloring book 24 with book cover 10, while outer surfaces 34 and 40 may be made from a stiffer material such as plastic so as to provide a firm coloring or drawing surface. In another example, first cover portion 12 and/or second cover portion 14 further include a stiff insert to provide a firm coloring surface. The overall dimensions of book cover 10 may vary according to the size and shape of the coloring book(s) to be accommodated.

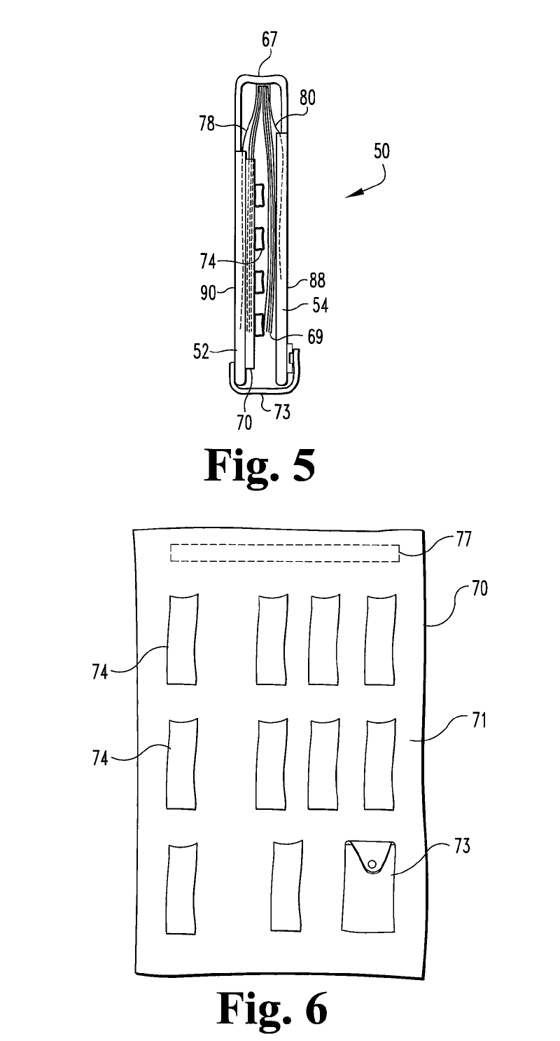

FIGS. 3-6 show a book cover 50 and storage page 70 according to second and third embodiments of the disclosed technology. In the embodiment in FIGS. 3-5, book cover 50 includes a first cover portion 52 and a second cover portion 54 and is capable of folding at a middle portion 67. First cover portion 52 includes an inner surface 86 and an outer surface 90 that together form a pocket 91 therebetween, which pocket 91 is accessible through a slot 56. First cover portion 52 further includes a fixing member 60, which may be a hook-and-loop type fastening system such as Velcro®, buttons, snaps, a zipper, an adhesive surface, magnets, another suitable fastening system, or a combination thereof. Second cover portion 54 includes an inner surface 84 and an outer surface 88 that together form a pocket 89 therebetween, which pocket 89 is accessible through a slot 58. Second cover portion 54 further includes a fixing member 62, which may be a hook-and-loop type fastening system such as Velcro®, buttons, snaps, a zipper, an adhesive surface, magnets, another suitable fastening system, or a combination thereof

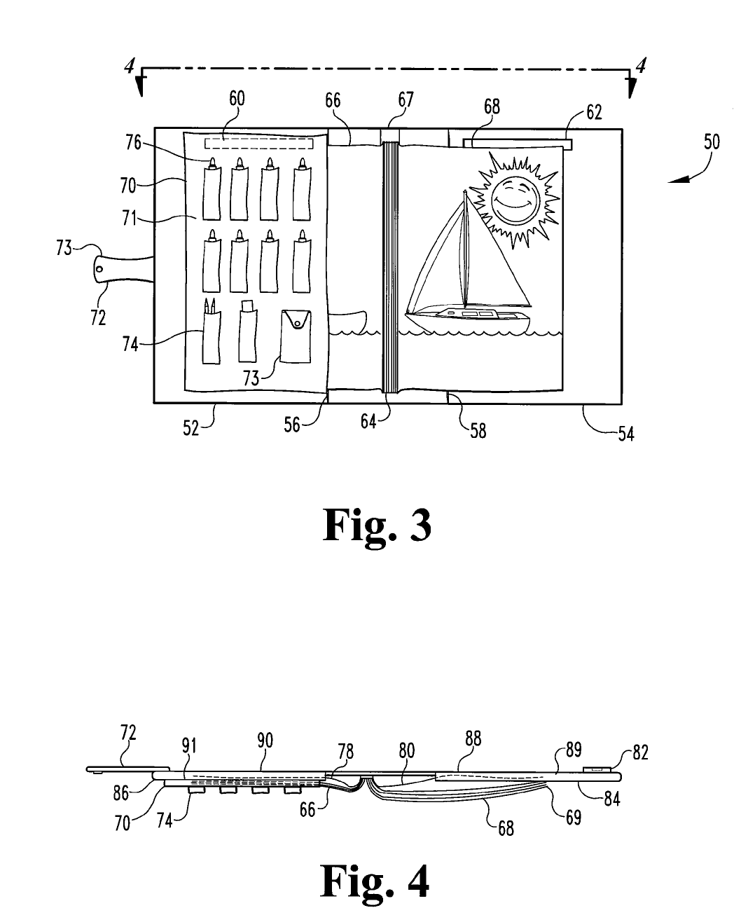

Continuing with the present example, a coloring book 64 having a front cover 78, a rear cover 80, and a plurality of colorable pages 69 disposed therebetween, of which a first page 66 and a second page 68 are visible in FIG. 3. Coloring book 64 is removably held by book cover 50 by inserting front coloring book cover 78 into pocket 91 through slot 56. Likewise, rear coloring book cover 80 is inserted into pocket 89 through slot 58. The size of pockets 89 and 91 is exaggerated in FIG. 4 for the sake of clarity. Book cover 50 further includes a closure device 73 comprising a hasp portion 72 and a latch portion 82 which removably latch together using a snap in this particular example. In other examples, a closure device may comprise two lengths of string or material that users may tie together, a hasp and latch that utilize a button, clasp, hook-and-loop fasteners, or other suitable latching means.

Book cover 50 further includes a storage page 70 comprising a surface 71 having a plurality of storage slots or pouches 74 disposed thereupon. Storage pouches 74 are sized and configured so as to accommodate the storage and removal of drawing or coloring implements 76 such as crayons, markers, pencils, and the like. Optionally, pouches 74 may further be configured so as to accommodate additional items normally associated with coloring and other arts and crafts activities such as glue, scissors, rulers, straight edges or drawing aids, tape, glitter, paint, brushes, and the like. Additionally, one or more closable pouches 73 may be included so as to contain smaller items such as paper clips, pins, and the like.

Storage page 70 is removably mountable to fixing member 60 or 62. In some embodiments, storage page 70 further includes a fixing member 77 corresponding to fixing members 60 and 62. For example, if fixing members 60 and 62 comprise a hook-and-loop type fastener strip then fixing member 70 would comprise a corresponding hook-and-loop type fastener strip. If fixing members 60 and 62 comprise an adhesive surface, then storage page 70 will not necessarily include a corresponding fixing member. Storage page 70 may be made from a soft and flexible material such as cloth or soft plastic or from harder and stiffer materials such as resins, cardboard, and the like.

In this particular example, storage page 70 is shown in FIG. 3 mounted to fixing member 60 so as to cover coloring book page 62. This configuration allows the child to color page 68 while coloring implements 76 are readily accessible and neatly organized on the facing storage page. The weight and positioning of storage page 70 also acts to hold coloring book pages not being used in position when the child is coloring in a windy environment such as a moving car. When not in use, book cover 50 is folded at middle portion 67, thereby enclosing coloring book 64, storage page 70, and coloring implements 76 safely and conveniently within book cover 50. Optionally, book cover 50 may be secured in the closed position using closure device 73.

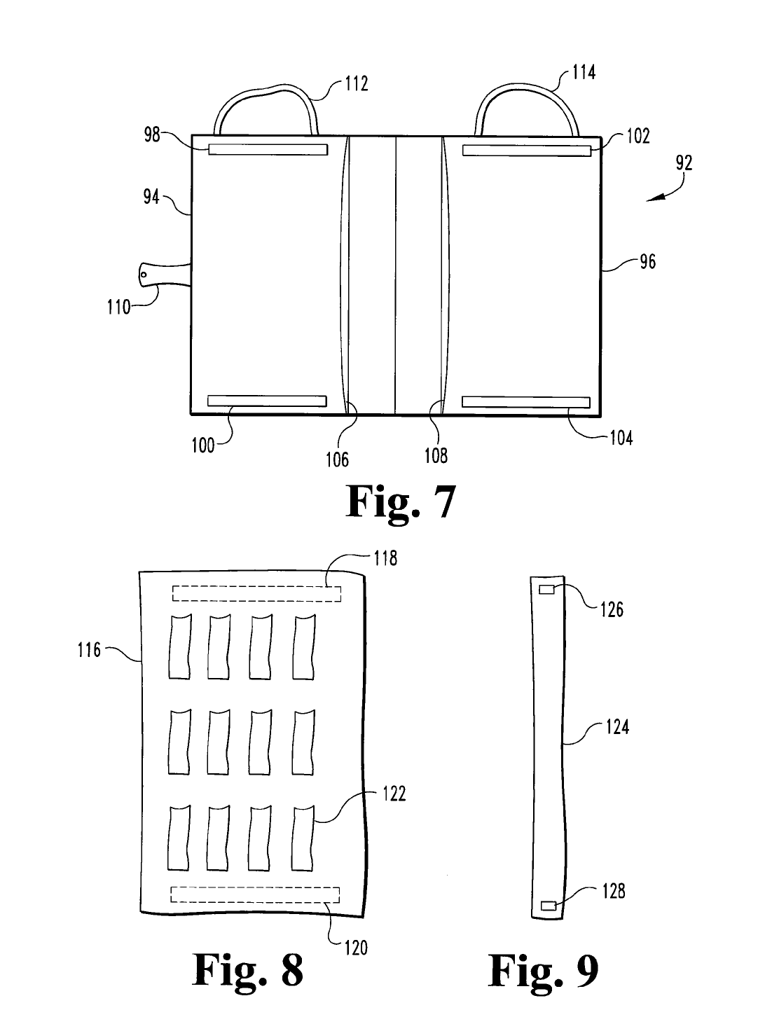

FIG. 7 shows yet another embodiment of a book cover 92. In this particular example, book cover 92 includes a first cover portion 94 and a second cover portion 96. First cover portion 94 includes a slot 106, a handle 112, and a latch 1 10. First cover portion 94 further includes a first fixing member 98 and a second fixing member 100. Second cover portion 96 includes a slot 108, a handle 114, a first fixing member 102, and a second fixing member 104. A storage page 116 such as that shown in FIG. 8 having a first fixing member 118, a second fixing member 120 and a plurality of storage locations 122 is suitable for use with book cover 92. A page holder 124 having a first fixing member 126 and a second fixing member 128 such as that shown in FIG. 9 allows the page of the coloring book being colored to be held in place by mounting page holder 124 to cook cover 92.

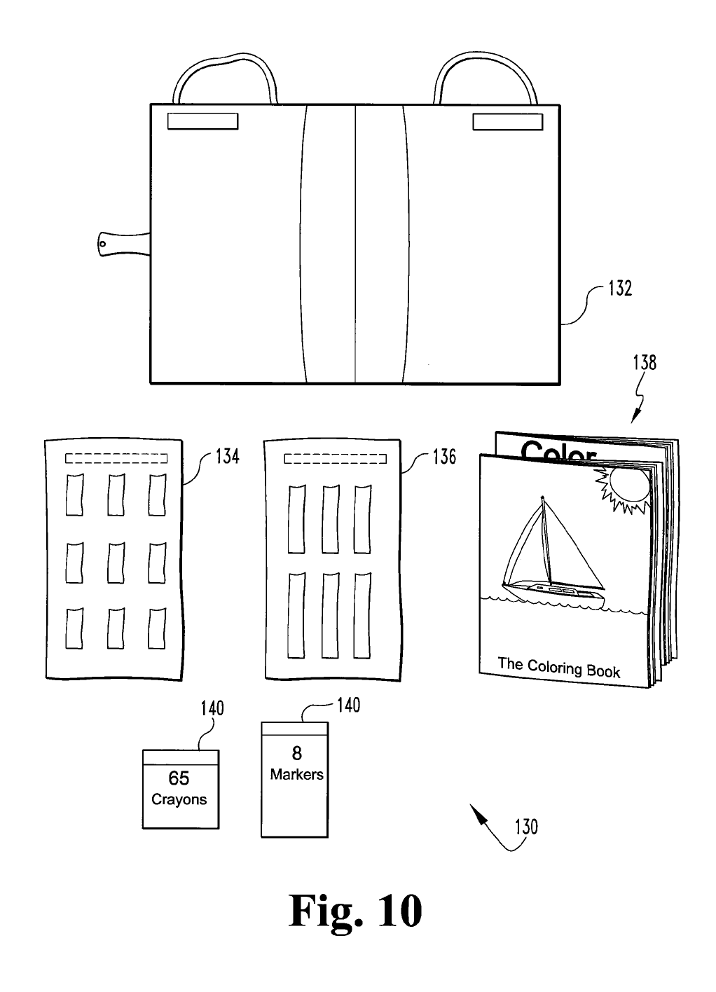

FIG. 10 shows a kit 130 comprising a book cover 132 according to one embodiment of the disclosed technology, two storage pages 134 and 136, a plurality of coloring books 138, and a plurality of coloring utensils 140. It is understood that other kits having a greater or lesser number of book covers, storage pages, coloring books, and/or coloring utensils may also be configured. It is also understood that the disclosed book covers may be configured and adapted for use with other arts and crafts projects, with such storage pages designed to hold art or drawing implements such as charcoals, pencils, colored pencils, erasers, brushes, and the like and a book cover designed to hold drawing tablets or sketch books with blank pages.

Book cover 92 includes a first cover portion 94 and a second cover portion 96. First cover portion 94 includes a slot 106, a handle 112, and a latch 1 10. First cover portion 94 further includes a first fixing member 98 and a second fixing member 100. Second cover portion 96 includes a slot 108, a handle 114, a first fixing member 102, and a second fixing member 104. A storage page 116 such as that shown in FIG. 8 having a first fixing member 118, a second fixing member 120 and a plurality of storage locations 122 is suitable for use with book cover 92. A page holder 124 having a first fixing member 126 and a second fixing member 128 such as that shown in FIG. 9 allows the page of the coloring book being colored to be held in place by mounting page holder 124 to cook cover 92.

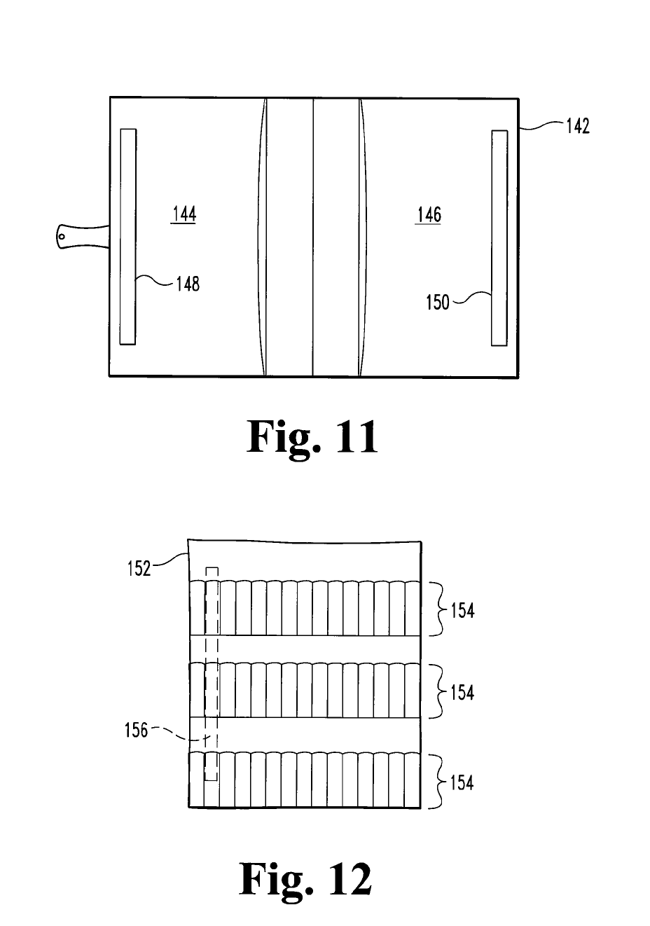

FIG. 11 illustrates a book cover 142 according to yet another embodiment. Book cover 142 includes a first cover portion 144 and a second cover portion 146, and further includes fixing members 148 and 150 near the outer edge of the facing surfaces of first cover portion 144 and second cover portion 146, respectively. A storage page 152 as shown in FIG. 12 includes several pockets 154 for holding coloring utensils or other supplies, and has fixing member 156 on its back for attachment to either fixing member 148 or 150.

While the disclosed technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the disclosed technology are desired to be protected.

What is claimed is:

1. A book cover kit, comprising:
a cover comprising
a first cover portion having a fixing member and a slot, the slot being sized and configured to receive a part of the cover of a coloring book therethrough; and
a second cover portion having a fixing member and a slot, the slot being sized and configured to receive another part of the cover of a coloring book therethrough; and
a storage page having a plurality of storage locations sized and configured to receive coloring implements;
wherein the storage page is removably mountable to the fixing member of the first cover portion and to the fixing member of the second cover portion.

2. The book cover kit of claim 1, wherein the coloring implements are crayons.

3. The book cover kit of claim 1, further comprising a closure device for temporarily maintaining the cover in a closed configuration.

4. The book cover kit of claim 1, wherein the fixing member of the first cover portion and the fixing member of the second cover portion each comprise a hook-and-loop fastener strip.

5. The book cover kit of claim 4, wherein:
the first cover portion and the second cover portion each have an inner edge and an outer edge, the inner edges being connected to each other and opposite the outer edges; and
the fixing member of the first cover portion and the fixing member of the second cover portion are each placed along the outer edge.

6. The book cover kit of claim 1, wherein the storage page further includes a fixing member that is complimentary to the fixing member of at least one of the first and second cover portions.

7. The book cover kit of claim 6, wherein:
the fixing member of the storage page comprises a hook-and-loop fastener strip; and
the fixing member of at least one of the first and second cover portions is a complimentary hook-and-loop fastener strip.

8. The book cover kit of claim 1, further comprising a second storage page
having a plurality of storage locations sized and configured to receive coloring implements; and
being removably mountable to the fixing member of the first cover portion, and alternatively removably mountable to the fixing member of the second cover portion.

9. The book cover kit of claim 1, wherein at least one of the first cover portion and the second cover portion includes a stiff insert.

10. The book cover kit of claim 1, further comprising:
a plurality of coloring implements; and
at least one coloring book.

11. The kit of claim 1, further comprising:
a plurality of drawing implements; and
at least one sketch pad.

12. A book cover comprising:
a first cover portion including an inner surface and an outer surface defining a pocket therebetween, the pocket being accessible by a slot sized and configured to receive the cover of a coloring book therethrough;
a first fixing member mounted to the inner surface of the first cover portion;
a second cover portion including an inner surface and an outer surface defining a pocket therebetween, the pocket being accessible by a slot sized and configured to receive the cover of a coloring book therethrough;
a second fixing member mounted to the inner surface of the second cover portion; and
a storage page having a plurality of storage locations sized and configured to receive coloring implements;
wherein the storage page is removably mountable to the fixing member of the first cover portion and to the fixing member of the second cover portion.

13. The book cover of claim 12, wherein the first cover portion further includes a closure device and the second cover portion further includes a closure device.

14. The book cover of claim 12, wherein the fixing member of the first cover portion and the fixing member of the second cover portion each comprise a hook-and-loop fastener.

15. The book cover of claim 12, wherein the storage page further includes a fixing member that is complimentary to at least one of the first and second fixing members.

16. The book cover of claim 15, wherein the fixing member of the storage page and the first and second fixing members each comprise a hook-and-loop fastener strip.

17. The book cover of claim 16, wherein:
the first cover portion and the second cover portion each have an inner edge and an outer edge, the inner edges being both connected to each other and opposite the outer edges; and
the fixing member of the first cover portion and the fixing member of the second cover portion are each placed along the outer edge.

18. The book cover of claim 12, further comprising a second storage page having a plurality of storage locations sized and configured to receive coloring implements and removably mountable to the fixing member of the first cover portion and to the fixing member of the second cover portion.

19. The book cover of claim 12, wherein the first cover portion further includes a handle portion and the second cover portion further includes a handle portion.

20. The book cover of claim 12, wherein at least one of the first cover portion and the second cover portion includes a stiff insert.
